(19) United States
(12) Patent Application Publication
(10) Pub. No.: US 2009/0238057 A1
(43) Pub. Date: Sep. 24, 2009

(54) Resin Composition, Optical Element, and Light Pickup Device

(75) Inventors: Yasumitsu Fujino, Tokyo (JP); Hiroko Ohmori, Kyoto (JP)

Correspondence Address: COHEN, PONTANI, LIEBERMAN & PAVANE LLP, 551 FIFTH AVENUE, SUITE 1210, NEW YORK, NY, 10176, US

(73) Assignee: KONICA MINOLTA OPTO, INC., Tokyo (JP)

(21) Appl. No.: 12/299,737

(22) PCT Filed: Apr. 13, 2007
(86) PCT No.: PCT/JP2007/058163

§ 371 Date: Nov. 5, 2008

(30) Foreign Application Priority Data
May 10, 2006 (JP) 2006-131374

(51) Int. Cl. G11B 7/00; C08L 31/00; C08L 69/00; C08L 77/00; G02F 1/361; G02B 1/04

(52) U.S. Cl. 369/100; 524/556; 524/611; 524/606; 524/570; 252/582; 359/580; G9B/7

(57) ABSTRACT

Objective lens 10 as an optical element of the present invention exhibits excellent optical stability maintained for a long duration. Disclosed is a resin composition constituting the optical element contains a thermoplastic resin, a curable resin, and inorganic particles having an average particle diameter of 1-50 nm.

### TECHNICAL FIELD

The present invention relates to a resin composition, an optical element made of the resin composition, and an optical pickup apparatus employing the optical element.

### BACKGROUND

Conventionally, devices to read and record information, such as a player, a recorder, a drive, and the like, are designed to be provided with an optical pickup apparatus for an optical information recording medium such as MO, CD, DVD or the like. The optical pickup apparatus is equipped with an optical element unit, in which after the optical information recording medium is exposed to light having predetermined wavelength produced from a light source, reflected light is received with a light receiving element, and the optical element unit possesses optical elements such as a lens and so forth to condense the light with a reflective layer of the optical information recording medium and the light receiving element.

The optical element of the optical pickup apparatus is preferably utilize a thermoplastic resin as a material in view of production at low cost via injection molding or the like, and a copolymer of cyclic olefin and α-olefin (refer to document 1, for example) and the like are known as the thermoplastic resin.

In the case of an information device such as a CD/DVD player capable of reading and writing information with respect to plural kinds of optical information recording media, the optical pickup apparatus is desired to have a structure adjustable to shapes of both optical information recording media as well as difference in wavelength of light. In this case, it is preferable that the optical element unit can be used in common with any of optical information recording media from the view point of cost and pickup characteristics.

In addition, as to an optical information recording medium capable of recording information with higher density than that of CD or DVD, in recent years, developed have been optical information recording media such as Blu-ray Disc and so forth to record and reproduce information with a shorter wavelength than that of CD (λ=780 nm) or DVD (λ=635 nm or 650 nm), and information devices to read and write information with these optical information recording media.

Document 1: Japanese Patent O.P.I. Publication No. 2002-105131 (page 4).

### DISCLOSURE OF THE INVENTION

### Problems to be Solved by the Invention

However, in the case of an optical element made of a thermoplastic resin described in Patent Document 1, when the optical element is exposed to light having a short wavelength of about 400 nm employed for recording and reproducing of information with a so-called next-generation DVD such as Blu-ray Disc or the like, white turbidity and deformation of the optical surface are produced in the optical element, whereby optical properties are degraded, and the optical element is frequently to be replaced.

It is an object of the present invention to provide a resin composition capable of maintaining excellent stability for a long duration, and an optical element and an optical pickup apparatus thereof.

### Means to Solve the Problems

The above-described object is accomplished by the following Structures of the present invention.

Structure 1 of the present invention: A resin composition comprising a thermoplastic resin, a curable resin, and inorganic particles having an average particle diameter of 1-50 nm.

Structure 2 of the present invention: The resin composition of Structure 1, wherein the inorganic particles comprise a semiconductor crystal composition, inorganic oxide, or an admixture of the semiconductor crystal composition and the inorganic oxide.

Structure 3 of the present invention: The resin composition of Structure 1 or 2, wherein the thermoplastic resin is at least one selected from the group consisting of an acrylic resin, an alicyclic hydrocarbon resin, a polycarbonate resin, a polyester resin, a polyether resin, a polyamide resin and a polyimide resin.

Structure 4 of the present invention: The resin composition of Structure 3,

wherein the thermoplastic resin is the alicyclic hydrocarbon resin, and the alicyclic hydrocarbon resin is a polymer represented by the following formula (1):

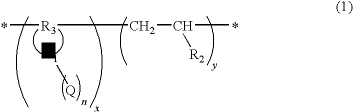

wherein each of x and y represents a copolymerization ratio, and is a real number satisfying 0/100≦y/x≦95/5; n is 0, 1 or 2, and represents a substitution number of substituent Q; R₁ represents at least one (2+n)-valent group selected from the group consisting of hydrocarbon groups each having 2-20 carbon atoms; R₂ represents a hydrogen atom or at least one monovalent group selected from the group consisting of hydrocarbon groups each having 1-10 carbon atoms; R₃ represents at least one divalent group selected from the group consisting of hydrocarbon groups each having 2-20 carbon atoms; and Q represents at least one monovalent group selected from the group consisting of structures each represented by COOR₄, where R₄ represents a hydrogen atom or at least one monovalent group selected from the group consisting of hydrocarbon groups each having 1-10 carbon atoms.

Structure 5 of the present invention: The resin composition of any one of Structures 1-4, comprising a stabilizer selected from the group consisting of a hindered amine stabilizer, a phenol stabilizer, a phosphorus stabilizer and a sulfur stabilizer.

Structure 6 of the present invention: An optical element comprising the resin composition of any one of Structures 1-5 as a molding.

Structure 7 of the present invention: The optical element of Structure 6, comprising the resin composition molded in a predetermined form by curing an uncured curable resin, after mixing the thermoplastic resin, the uncured curable resin and the inorganic particles.

Structure 8 of the present invention: The optical element of Structure 6 or 7, comprising a fine structure provided on at least one optical surface.

Structure 9 of the present invention: The optical element of any one of Structures 6-8, comprising a collimation function.

Structure 10 of the present invention: The optical element of any one of Structures 6-9, comprising the resin composition, as the molding having a thickness of 3 mm, exhibiting a high light transmittance of at least 85% with respect to light having a wavelength of 400 nm.

Structure 11 of the present invention: An optical pickup apparatus to reproduce and/or record information for an optical information recording medium, comprising a light source to emit light, and an optical element unit to conduct irradiation onto light the information recording medium with light emitted from the light source and/or collimation of light reflected on the optical information recording medium, wherein the optical element unit comprises the optical element of any one of Structures 6-10.

Structure 12 of the present invention: The optical pickup apparatus of Structure 11, comprising the light source emitting light having a wavelength of 390-420 nm.

### EFFECT OF THE INVENTION

It is a feature that a resin composition of any one of Structures 1-4 according to the present invention possesses at least a thermoplastic resin, a curable resin, and inorganic particles having an average particle diameter of 1-50 nm, and an optical element fitted with the resin composition exhibits a high stabilization effect against exposure to light, whereby white turbidity and change in refractive index are inhibited even though the optical element is exposed to light having a short wavelength of about 400 nm, and deformation of an optical surface at high temperature of around 85° C., for example, can be inhibited for a long duration. That is, not only optical stability and thermal stability of the optical element can be improved, but also these properties can be improved for a long duration.

Since at least one selected from the group consisting of a stabilizer selected from the group consisting of a hindered amine stabilizer, a phenol stabilizer, a phosphorus stabilizer and a sulfur stabilizer in Structure 5 according to the present invention is appropriately added, variation of optical properties of a molded optical element can be effectively inhibited.

In Structures 6 and 7 according to the present invention, the same effect as that in the invention described in any one of Structures 1-5 can be obtained.

In Structure 8 according to the present invention, a fine structure is provided on at least one optical surface, and since this optical element is formed by molding the resin composition of any one of Structures 1-5, it exhibits high shape stability against environmental variation caused by light or heat, and deformation of the fine structure can be appropriately inhibited.

In Structure 9 according to the present invention, optical properties of the optical element are not degraded since the optical element exhibits high shape stability, even though it has a collimation function. That is, even though the optical element receives high energy via collimation, it is possible to inhibit deformation of the optical element for a long duration because of high shape stability which the optical element exhibits, whereby degradation of optical properties of the optical element can be controlled.

In Structure 10 according to the present invention, since it can be inhibited that white turbidity, change in refractive index and so forth are produced in a molding even though the resin composition, as the molding having a thickness of 3 mm, exhibits high shape stability, and light having a high energy wavelength of about 400 nm passes through it, a high light transmittance of at least 85% can be set with respect to light having a wavelength of about 400 nm.

Accordingly, the resin composition can be suitably utilized for an optical element with an optical information recording medium having high information density like a Blu-ray Disc, for example.

In Structure 11 according to the present invention, since an optical element unit is equipped with the optical element of any one of Structures 6-10, white turbidity and change in refractive index are inhibited even though a stabilization effect is high with respect to exposure to light, and exposure to light having a short wavelength of about 400 nm, for example, is continuously received, and deformation of the optical surface at a high temperature of about 85° C. can be inhibited for a long duration. That is, optical stability of the optical element can be improved, and the optical properties can be maintained for a long duration.

Accordingly, reading and writing of information can be conducted for a long duration with excellent pickup characteristics for an optical information recording medium having high information density like a Blu-ray Disc, whereby an optical pickup apparatus exhibiting high reliability can be obtained.

In Structure 12 according to the present invention, light emitted from a light source has a wavelength of 390-420 nm. Even in the case of transmission of light having a wavelength of 390-420 nm suitably matched with an optical information recording medium, degradation of the optical element concerning white turbidity and change in refractive index can be inhibited since the resin composition utilized for the optical element of the present invention contains at least a thermoplastic resin and a curable resin. This can extend lifetime of the optical element, whereby an optical pickup apparatus exhibiting high reliability can be obtained.

### BRIEF DESCRIPTION OF THE DRAWINGS

FIG. 1 is a schematic cross-sectional side view of optical pickup apparatus 1.

FIG. 2 is a cross-sectional side view of objective lens 10.

FIG. 3 is a cross-sectional side view of objective lens 10a.

FIG. 4 is a cross-sectional side view of objective lens 10b.

FIG. 5 is a cross-sectional side view of objective lens 10c.

FIG. 6 is a cross-sectional side view of objective lens 10d.

FIG. 7 is a cross-sectional side view of hologram optical element 10e and objective lens 10f.

### EXPLANATION OF NUMERALS

1 Optical pickup apparatus
2 Light source
3 Collimator lens (a part of an optical unit)
4 Optical axis
5 Optical information recording medium
6 information recording surface
7 Polarization beam splitter (a part of an optical unit)
8 Detector
10, 10a, 10b, 10c, 10d, 10f Objective lens (a part of an optical unit or optical element)
11, 11a, 11d, 12d, 22b Optical surface
20, 20a, 20b, 20c, 20d Optical path difference providing structure
21 First orbicular zone-shaped lens surface (orbicular zone-shaped lens surface)
21a, 21d Diffractive orbicular zone
21b Orbicular zone-shaped concave portion
22 Second orbicular zone-shaped lens surface (orbicular zone-shaped lens surface)
23 Third orbicular zone-shaped lens surface (orbicular zone-shaped lens surface)
23b Orbicular zone-shaped convex portion

### DESCRIPTION OF THE PREFERRED EMBODIMENTS

Next, the preferred embodiments of the present invention will be explained referring to figures. Technically preferable, various limitations of the present invention are provided in embodiments described below, but the scope of the present invention is not limited to the following embodiments and examples of the figures.

A resin composition constituting an optical element of the present invention contains at least a thermoplastic resin, a curable resin and inorganic particles.

The thermoplastic resin, in the nature of it, produces a critical problem such as deformed shape of the optical element in the case of application for use at high temperature.

In response, after considerable effort during intensive studies, the inventors have found out that when after forming a resin composition in which at least a specific thermoplastic resin and an uncured curable resin are evenly mixed in an arbitrary shape, the curable resin is cured and molded via exposure to actinic energy radiation such as UV radiation, electron beams or the like, and application of heat, the resulting optical element exhibits a high stabilization effect against exposure to light together with obtained transparency, whereby white turbidity and change in refractive index are inhibited even though the optical element is exposed to light having a short wavelength of about 400 nm, and deformation of the optical surface at high temperature of around 85° C., for example, can be inhibited for a long duration. That is, it was confirmed that not only transparency of the optical element was obtained, but also optical stability and thermal stability were possible to be improved, and an element capable of maintaining these properties for a long duration was possible to be manufactured.

Next, each of (1) thermoplastic resin, (2) curable resin, and (3) inorganic particle contained in a resin composition will be described, and (4) additives which can be added into the resin composition, (5) method of manufacturing optical element, and (6) optical pickup apparatus in which the optical element is utilized will be subsequently described.

### (1) Thermoplastic Resin

Examples of the thermoplastic resin include transparent resins such as an acrylic resin, an alicyclic hydrocarbon resin, a polycarbonate resin, a polyester resin, a polyether resin, a polyamide resin, a polyimide resin and so forth, but of these, specifically, an alicyclic hydrocarbon resin is preferably used in order to obtain the above-described effect. The alicyclic hydrocarbon resin represented by the following formula (1) is exemplified below.

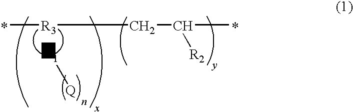

In the above-described formula (1), each of x and y represents a copolymerization ratio, and is a real number satisfying 0/100≦y/x≦95/5; n is 0, 1 or 2, and represents a substitution number of substituent Q; R₁ represents at least one (2+n)-valent group selected from the group consisting of hydrocarbon groups each having 2-20 carbon atoms; R₂ represents a hydrogen atom or at least one monovalent group selected from the group consisting of hydrocarbon groups each having 1-10 carbon atoms; R₃ represents at least one divalent group selected from the group consisting of hydrocarbon groups each having 2-20 carbon atoms; and Q represents at least one monovalent group selected from the group consisting of structures each represented by COOR₄, where R₄ represents a hydrogen atom or at least one monovalent group selected from the group consisting of hydrocarbon groups each having 1-10 carbon atoms.

In the above-described formula (1), R₁ preferably represents at least one divalent group selected from the group of consisting of hydrocarbons each having 2-12 carbon atoms, more preferably is a divalent group represented by the following formula (2), and still more preferably represents a divalent group in which p in the following formula (2) is 0 or 1.

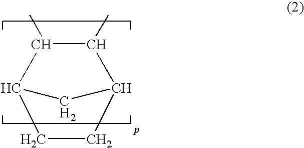

In the above-described formula (2), p is an integer of 0-2.

The structure of R₁ may be used singly or in combination of at least two kinds.

Examples of R₂ include a hydrogen atom, a methyl group, an ethyl group, an n-propyl group, an i-propyl group, an n-butyl group, 2-methypropyl group and so forth, but at least one of the hydrogen atom and the methyl group is preferable, and the hydrogen atom is more preferable.

As to an example of R₃, as a preferred example of a structure unit possessing this group, for example, the following formulae (3a), (3b) and (3c) are provided in the case of n=0.

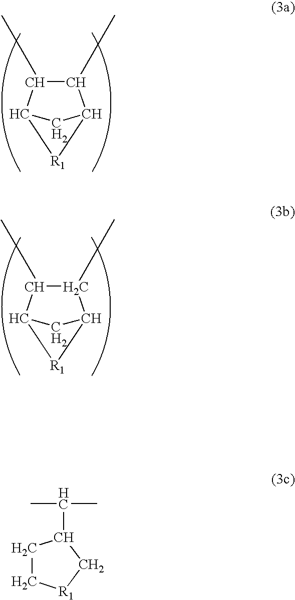

In addition, R₁ in the above-described formulae (3a), (3b) and (3c) is as described before, and n is preferably 0.

In the present invention, copolymerization types are not particularly limited, and commonly known copolymerization types such as random copolymerization, block copolymerization, alternate copolymerization and so forth can be utilized, but the random copolymerization is preferable.

Further, a copolymer used in the present invention may possess a repeating unit derived from other copolymerizable monomers, if desired, to the extent that matter properties of products obtained via a molding method of the present invention are not degraded. The copolymerization ratio is not particularly limited, but it is preferably 20 mol % or less, and more preferably 10 mol % or less. In the case of a copolymerization ratio exceeding 20 mol %, high precision optical parts tend not to be obtained since optical properties are degraded. The copolymerization type in this case is not particularly limited, but random coploymerization is preferable.

Next, alicyclic hydrocarbon based copolymers represented by the above-described formula (1) are specifically exemplified.

An α-olefin.cyclic olefin random copolymer obtained via copolymerization of α-olefin having 2-20 carbon atoms and cyclic olefin represented in formula (4) is described as an example, but nothing is limited to the alicyclic hydrocarbon based copolymers of the present invention.

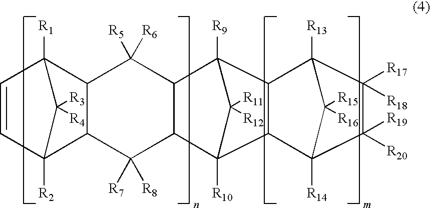

In the above-described formula (4), n is 0 or 1, and m is an integer of 0 or at least 1. Each of R₁-R₂₀ independently represent a hydrogen atom, a halogen atom or a hydrocarbon group. Herein, the halogen atom is a fluorine atom, a chlorine atom, a bromine atom or an iodine atom.

Further, the hydrocarbon group independently represents an alkyl group having 1-20 carbon atoms, a cycloalkyl group having 3-15 carbon atoms or an aromatic hydrocarbon group. Specific examples of the alkyl group include a methyl group, an ethyl group, a propyl group, an isopropyl group, an amyl group, a hexyl group, an octyl group, a decyl group, a dodecyl group and an octadecyl group. An example of the cycloalkyl group is a cyclohexyl group. Examples of the aromatic hydrocarbon group include a phenyl group and a naphtyl group. In these hydrocarbon groups, a hydrogen atom may be substituted by a halogen atom.

Further, in the above-described formula (4), R₁₇-R₂₀ may be binded to each other to form monocycle or polycycle, and the monocycle or the plycycle formed in such a manner may possess a double bond.

Examples of the cyclic olefin represented by the above-described formula (4) will be specifically given below. As an example, provided are bicyclo[2.2.1]hepta-2-ene {otherwise known as norbornene, wherein numerals 1-7 each indicate a position number of a carbon atom in the following formula (5)} represented by the following formula (5), and a derivative in which this compound is substituted by a hydrocarbon group.

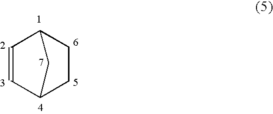

Examples of the hydrocarbon group obtained via this substitution include 5-methyl, 5,6-dimethyl, 1-methyl, 5-ethyl, 5-n-butyl, 5-isobutyl, 7-methyl, 5-phenyl, 5-methyl-S-phenyl, 5-benzyl, 5-tolyl, 5-(ethylphenyl), 5-(isopropylphenyl), 5-(biphenyl), 5-(β-naphtyl), 5-α-naphtyl), 5-(antracenyl), 5,6-diphenyl, and so forth.

Further, provided are tricyclo[4.3.0.1^{2,5}]deca-3-ene derivatives such as tricyclo[4.3.0.1^{2,5}]deca-3-ene, 2-methyltricyclo[4.3.0.1^{2,5}]deca-3-ene, 5-methyltricyclo[4.3.0.1^{2,5}]deca-3-ene and so forth; tricyclo[4.4.0.1^{2,5}]undeca-3-ene derivatives such as tricyclo[4.4.0.1^{2,5}]undeca-3-ene and 10-methyltricyclo[4.4.0.1^{2,5}]undeca-3-ene and so forth; tetracyclo[4.4.0.1^{2,5}.1^{7,10}]dodeca-3-ene represented by formula (6) (hereinafter, referred to simply as “tetracyclododecene”, and numerals 1-12 each indicate a position number of a carbon atom); and a derivative in which this is substituted by a hydrocarbon group.

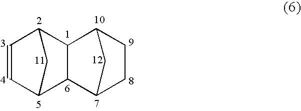

Examples of the hydrocarbon group for the substituent include 8-methyl, 8-ethyl, 8-propyl, 8-butyl, 8-isobutyl, 8-hexyl, 8-cyclohexyl, 8-stearyl, 5,10-dimethyl, 2,10-dimethyl, 8,9-dimethyl, 8-ethyl-9-methyl, 11,12-dimethyl, 2,7,9-trimethyl, 2,7-dimethyl-9-ethyl, 9-isobutyl-2,7-dimethyl, 9,11,12-trimethyl, 9-ethyl-11,12-dimethyl, 9-isobutyl-11,12-dimethyl, 5,8,9,10-tetramethyl, 8-ethylidene, 8-ethylidene-9-methyl, 8-ethylidene-9-ethyl, 8-ethylidene-9-isopropyl, 8-ethylidene-9-butyl, 8-n-propylidene, 8-n-propylidene-9-methyl, 8-n-propylidene-9-ethyl, 8-n-propylidene-9-isopropyl, 8-n-propylidene-9-butyl, 8-isopropylidene, 8-isopropylidene-9-methyl, 8-isopropylidene-9-ethyl, 8-isopropylidene-9-isopropyl, 8-isopropylidene-9-butyl, 8-chloro, 8-bromo, 8-fluoro, 8,9-dichloro, 8-phenyl, 8-methyl-8-phenyl, 8-benzyl, 8-tolyl, 8-(ethylphenyl), 8-(isopropylphenyl), 8,9-diphenyl, 8-(biphenyl), 8-(β-naphtyl), 8-(α-naphtyl), 8-(antracenyl), 5,6-diphenyl, and so forth.

Further, examples of addition polymerizable monomers employed during copolymerization include linear α-olefin having 2-20 carbon atoms such as ethylene, propylene, buta-1-ene, penta-1-ene, hexa-1-ene, octa-1-ene, deca-1-ene, dodeca-1-ene, tetradeca-1-ene, hexadeca-1-ene, octadeca-1-ene, eicosa-1-ene and so forth; and branched α-olefin having 4-20 carbon atoms such as 3-methylbuta-1-ene, 3-methylpenta-1-ene, 3-ethylpenta-1-ene, 4-methylpenta-1-ene, 4-methylhexa-1-ene, 4,4-dimethylhexa-1-ene, 4,4-dimethylpenta-1-ene, 4-ethylhexa-1-ene, 3-ethylhexa-1-ene and so forth. Of these, linear α-olefin having 2-4 carbon atoms is preferable, and ethylene is specifically preferable. Such the linear or branched α-olefin is used singly or in combination of at least two kinds.

As to a method of manufacturing alicyclic hydrocarbon based copolymers, copolymerization reaction is conducted in a hydrocarbon solvent employing α-olefin having 2-20 carbon atoms and cyclic olefin represented by the above-described formula (4), and they are prepared with a catalyst formed from a vanadium compound and an organic aluminum compound which are soluble in this hydrocarbon solvent, or with a catalyst formed from a transition metal compound containing a ligand having a cyclopentadienyl structure, an organic aluminum oxy compound and an organic aluminum compound added if desired. For example, the conditions may be appropriately selected in accordance with methods proposed in Japanese Patent O.P.I. Publication No. 60-168708, Japanese Patent O.P.I. Publication No. 61-120816, Japanese Patent O.P.I. Publication No. 61-115912, Japanese Patent O.P.I. Publication No. 61-115916, Japanese Patent O.P.I. Publication No. 61-271308, Japanese Patent O.P.I. Publication No. 61-272216, Japanese Patent O.P.I. Publication No. 62-252406, Japanese Patent O.P.I. Publication No. 62-252407 and so forth. The optical element prepared employing a resin composition containing the resulting polymer exhibits high stabilization effect against exposure to light, and inhibits white turbidity and change in refractive index even though the optical element is exposed to light having a short wavelength of about 400 nm, for example, and can also inhibit deformation of the optical surface. Accordingly, optical stability of an optical element can be improved, and it is possible to prepare an optical element capable of maintaining the properties for a long duration.

As another example of a thermoplastic alicyclic hydrocarbon based copolymer preferably applied for an optical element of the present invention, provided is a polymer in which a repeating unit having a alicyclic structure contains repeating unit (a) having an alicyclic structure represented by the following formula (7) and repeating unit (b) of a chain structure represented by the following formula (8) and/or the following formula (9) and/or the following formula (10) so as to give a total content of at least 90% by weight, and repeating unit (b) has a content of at least 1% by weight and less than 10% by weight.

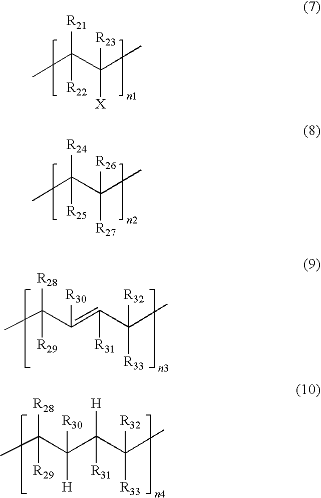

In formulae (7)-(10), each of R₂₁-R₃₃ independently represents a hydrogen atom, a chain hydrocarbon group, a halogen atom, an alkoxy group, a hydroxyl group, an ether group, an ester group, a cyano group, an amino group, an imido group, a silyl group and a chain hydrocarbon group substituted by a polar group (a halogen atom, an alkoxy group, a hydroxyl group, an ester group, a cyano group, an amide group, an imide group or a silyl group).

Specific examples of the halogen atom include a fluorine atom, a chlorine atom, a bromine atom and an iodine atom, and as the chain hydrocarbon group substituted by a polar group, for example, provided is a halogenated alkyl group having 1-20 carbon atoms, preferably a halogenated alkyl group having 1-10 carbon atoms, but more preferably a halogenated alkyl group having 1-6 carbon atoms.

Examples of the chain hydrocarbon group include an alkyl group having 1-20 carbon atoms, preferably an alkyl group having 1-10 carbon atoms, but more preferably an alkyl group having 1-6 carbon atoms; and an alkenyl group having 2-20 carbon atoms, preferably an alkenyl group having 2-10 carbon atoms, but more preferably an alkenyl group having 2-6 carbon atoms.

In the above-described formula (7), X represents an alicyclic hydrocarbon group, and the carbon number constituting it is generally 4-20, preferably 4-10 and more preferably 5-7. By setting the carbon number constituting an alicyclic structure within this range, birefringence can be reduced. Further, an alicyclic structure may include not only a monocyclic structure but also a polycyclic structure such as a norbornane ring or the like.

The alicyclic hydrocarbon group may possess a carbon-carbon unsaturated bond, but the content is 10% or less, based on the total carbon-carbon bonds, preferably 5% or less, and more preferably 3% or less. By setting the content of carbon-carbon unsaturated bonds of the alicyclic hydrocarbon group within this range, transparency and heat resistance are improved.

Further, to carbon atoms constituting an alicyclic hydrocarbon group, bonded may be a chain hydrocarbon group substituted by a polar group (a halogen atom, an alkoxy group, a hydroxyl group, an ester group, a cyano group, an amide group, an imide group or a silyl group). Among them, a chain hydrocarbon group having 1-6 hydrogen atoms or carbon atoms is preferable in view of heat resistance and a low water-absorbing property.

Further, in the above-described formula (9), a carbon-carbon unsaturated bond is contained in the main chain, and in the above-described formula (10), a carbon-carbon saturated bond is contained in the main chain, but a content of the unsaturated bond is generally 10% by weight or less, based on the total carbon-carbon bonds constituting the main chain, preferably 5% by weight or less, and more preferably 3% by weight or less, when transparency and heat resistance are strongly desired.

In the present invention, the total content of repeating unit (a) having an alicyclic structure represented by the above-described formula (7) and repeating unit (b) having a chain structure represented by the above-described formula (8) and/or the above-described formula (9) and/or the above-described formula (10), in an alicyclic hydrocarbon based copolymer, is generally at least 90% by weight, preferably at least 95% by weight, and more preferably at least 97%, based on weight. By setting the total content within the above-described range, low birefringence, heat resistance, a low water-absorbing property and mechanical strength are suitably balanced.

As a method of manufacturing an alicyclic hydrocarbon based copolymer, provided is a method of hydrogenating carbon-carbon unsaturated bonds in the main chain and aromatic ring via copolymerization of an aromatic vinyl based compound and another copolymerizable monomer.

The molecular weight of a copolymer before hydrogenation is 1,000-1,000,000 as a polystyrene (or polyisoprene) equivalent weight average molecular weight (Mw) measured by GCP, preferably 5,000-500,000, and more preferably 10,000-300,000. A strength characteristic of the resulting alicyclic hydrocarbon based copolymer molding product is degraded when the weight average molecular weight (Mw) of the copolymer is excessively small, while the hydrogenation reactivity is degraded when in contrast, it is excessively large.

Specific examples of aromatic vinyl based compounds utilized in the above-described method include styrene, α-methylstyrene, α-ethylstyrene, α-propylstyrene, α-isopropylstyrene, α-t-butylstyrene, 2-methylstyrene, 3-methylstyrene, 4-methylstyrene, 2,4-diisopropylstyrene, 2,4-dimethylstyrene, 4-t-butylstyrene, 5-t-butyl-2-methylstyrene, monochlorostyrene, dichlorostyrene, monofluorostyrene and 4-phenylstyrene. Of these, styrene, 2-methylstyrene, 3-methylstyrene and 4-methylstyrene are preferable. These aromatic vinyl based compounds can be utilized singly or in combination of at least two kinds.

Other copolymerizable monomers are not specifically limited, but utilized are chain vinyl compounds and chain conjugated diene compounds. In cases where chain conjugated diene compounds are employed, not only the operating properties in the manufacturing process is excellent, but also a strength characteristic of the resulting alicyclic hydrocarbon based copolymer is excellent.

Specific examples of chain vinyl compounds include chain olefin monomers such as ethylene, propylene, 1-butene, 1-pentene and 4-methyl-1-pentene; nitrile based monomers such as 1-cyanoethylene (acrylonitrile), 1-cyano-1-methylethylene (methacrylonitrile) and 1-cyano-1-chloroethylene α-chloroacrylonitrile), (meth)acrylic acid ester based monomers such as 1-(methoxycarbonyl)-1-methylethylene (methacrylic acid methyl ester), 1-(ethoxycarbonyl)-1-methylethylene (methacrylic acid ethyl ester), 1-(propoxycarbonyl)-1-methylethylene (methacrylic acid propyl ester), 1-(butoxycarbonyl)-1-methylethylene (methacrylic acid butyl ester), 1-methoxycarbonylethylene (acrylic acid methyl ester), 1-ethoxycarbonylethylene (acrylic acid ethyl ester), 1-propoxycarbonylethylene (acrylic acid propyl ester) and 1-butoxycarbonylethylene (acrylic acid butyl ester); unsaturated fatty acid based monomers such as 1-carboxyethylene (acrylic acid), 1-carboxy-1-methylethylene (methacrylic acid) and maleic anhydride. Of these, chain olefin monomers are preferable, and ethylene, propylene and 1-butene are most preferable.

Examples of chain conjugated dienes include 1,3-butadiene, isoprene, 2,3-dimethyl-1,3-butadiene, 1,3-pentadiene and 1,3-hexadiene.

Among these chain vinyl compounds and chain conjugated dienes, chain conjugated dienes are preferable, and butadiene and isoprene are specifically preferable. These chain vinyl compounds and chain conjugated dienes can be used singly or in combination of at least two kinds.

The polymerization reaction via radical polymerization, anion polymerization, cation polymerization or the like is not specifically limited, but anion polymerization is preferable in view of polymerization operation, easiness of hydrogenation reaction in a post process, and mechanical strength of a finally obtained hydrocarbon based copolymer.

In the case of anion polymerization, employed can be block polymerization, solution polymerization, slurry polymerization and so forth in the presence of an initiator, in a temperature of generally 0-200° C., preferably in a temperature of 20-100° C., and specifically preferably in a temperature of 20-80° C., but solution polymerization is preferable in view of removal of reaction heat.

In this case, an inert solvent capable of dissolving a polymer and a hydrogenated product thereof is used.

Examples of inert solvents employed in solution reaction include aliphatic hydrocarbons such as n-butane, n-pentane, iso-pentane, n-hexane, n-heptane, iso-octane and so forth; alicyclic hydrocarbons such as cyclopentane, cyclohexane, methylcyclopentane, methylcyclohexane, decalin and so forth; and aromatic hydrocarbons such as benzene, toluene and so forth.

As an initiator for the above-described anion polymerization, usable are, for example, mono-organolithium compounds such as n-butyl lithium, sec-butyl lithium, t-butyl lithium, hexyl lithium, phenyl lithum and so forth; and polyfunctional organolithium compounds such as dilithiomethane, 1,4-diobutane, 1,4-dilithio-2-ethylcyclohexane and so forth.

In cases where hydrogenation of carbon-carbon double bonds in an unsaturated ring such as an aromatic ring and a cycloalkene ring or of unsaturated bonds in the main chain in copolymers before hydrogenation is conducted, the reaction method and reaction form are not specifically limited, and can be performed in accordance with a commonly known method, but preferred is a hydrogenation method which can increase a hydrogenation degree, and can decrease polymer chain cleaving reaction caused simultaneously with the hydrogenation. Listed is a method employing a catalyst containing at least one metal selected from nickel, cobalt, iron, titanium, rhodium, palladium, platinum, ruthenium and rhenium, in an organic solvent. The hydrogenation reaction is generally conducted at a temperature of 10-250° C., but preferably conducted at a temperature of 50-200° C., and more preferably conducted at a temperature of 80-180° C., from the reason of an increasing hydrogenation degree as well as decreasing a polymer chain cleaving reaction caused simultaneously with hydrogenation reaction. Further, hydrogen pressure is generally 0.1-30 MPa, but it is preferably 1-20 MPa in view of easy operation, and more preferably 2-10 Mpa.

The hydrogenation ratio of thus obtained hydrogenated products is generally at least 90%, preferably at least 95% and more preferably at least 97%, based on ¹H-NMR measurement, in the case of any of carbon-carbon unsaturated bonds of a main chain, carbon-carbon double bonds of an aromatic ring and carbon-carbon double bonds of an unsaturated ring. A low birefringence property, thermal stability and so forth are deteriorated when the hydrogenation ratio is low.

A method to recover a hydrogenated product after completing the hydrogenation reaction is not specifically limited. Usually, utilized can be a method in which a solvent is removed from the hydrogenated product solution via direct drying after elimination of the residue of a hydrogenation catalyst via processes such as filtration and centrifugal separation, and a method in which the hydrogenated product solution is poured into a poor solvent for the hydrogenated product to solidify the hydrogenated product.

Further, as a thermoplastic resin employed in the present invention, a transparent resin material generally used as an optical material can be provided, and the example is exemplified below.

(1.1) Specific examples of polymers derived from hydrocarbon having one or two unsaturated bonds include polyolefin such as polyethylene, polypropylene, polymethylbuta-1-ene, poly-4-methylpenta-1-ene, polybuta-1-ene, polystyrene and so forth. In addition, the polyolefin may possess a crosslinking structure.

(1.2) Specific examples of halogen-containing vinyl polymers include polyvinyl chloride, polyvinylidene chloride, polyvinyl fluoride, polychloroprene, chlorinated rubber and so forth.

(1.3) Specific examples of polymers derived from α,β-unsaturated acid and its derivatives include polyacrylate, polymethacrylate, polyacrylamide and polyacrylonitrile, or specific examples of the copolymer produced with a monomer constituting the foregoing polymer include an acrylonitrile.butadiene.styrene copolymer, an acrylonitrile.styrene copolymer, an acrylonitrile styrene acrylic acid ester copolymer and so forth.

(1.4) Specific examples of the polymer derived from unsaturated alcohol and amine, or an acylated derivative or acetal of unsaturated alcohol include polyvinyl alcohol, polyvinyl acetate, polyvinyl stearate, polyvinyl benzoate, polyvinyl maleate, polyvinyl butyral, polyallyl phthalate, polyallyl meramine; or a copolymer produced with a monomer constituting the foregoing polymer such as an ethylene.vinylacetate copolymer and so forth.

(1.5) Specific examples of polymers derived from epoxide include polymers derived from polyethyleneoxide or bisglycidyl ether.

(1.6) Specific examples of polyacetals include polyoxymethylene, polyoxyethylene, and polyoxymethylene containing ethyleneoxide as a comonomer.

(1.7) Polyphenyleneoxide

(1.8) Polycarbonate

(1.9) S polysulfone

(1.10) Polyurethane and a urea resin

(1.11) Specific examples of polyamide or copolyamide derived from diamine and a dicarboxylic acid and/or an amino carboxylic acid, or corresponding lactam include nylon 6, nylon 66, nylon 11, nylon 12.

(1.12) Specific examples of polyester derived from a dicarboxylic acid and dialcohol and/or an oxycaroxylic acid, or corresponding lactone include polyethylene terephthalate, polybutylene terephthalate, poly 1,4-dimethylol.cyclohexane terephthalate, and so forth.

(1.13) Specific examples of the polymer having a crosslinking structure, derived from aldehyde and phenol, and urea or meramine include a phenol.formaldehyde resin, a urea.formaldehyde resin, a meramine.formaldehyde resin and so forth.

(1.14) An alkyd resin, such as a glycerin.phthalic acid resin or the like.

(1.15) An unsaturated polyester resin and a halogen-containing modified resin, obtained with a vinyl compound as a crosslinking agent by deriving from copolyester of a saturated and unsaturated dicarboxylic acid with polyhydric alcohol.

(1.16) Specific examples of natural polymers include cellulose, rubber, protein, and their derivatives such as cellulose acetate, cellulose propionate, cellulose ether and so forth.

(1.17) Specific examples of soft polymers include a soft polymer containing a cyclic olefin component, α-olefin based copolymer, α-olefin.diene based copolymer, an aromatic vinyl based hydrocarbon.conjugated diene based soft copolymer, soft polymers or copolymers made of isobutylene or isobutylene conjugated diene.

The thermoplastic resin of the present invention is preferably at least one selected from the group consisting of an acryl resin, a cyclic olefin resin, a polycarbonate resin, a polyester resin, a polyether resin, a polyamide resin and a polyimide resin. For example, provided can be compounds described in Table 1 of Japanese Patent O.P.I. Publication No. 2003-73559, and the preferable compounds are shown in Table 1.

TABLE 1

| | | Refractive | Abbe's |
|---|---|---|---|
| | Structure | Index n | number v |
| 1 | 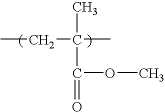 | 1.49 | 58 |
| 2 | 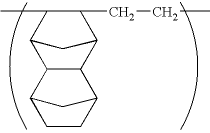 | 1.54 | 56 |
| 3 | 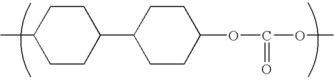 | 1.53 | 57 |
| 4 | 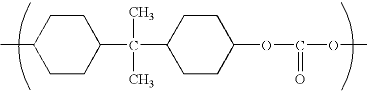 | 1.51 | 58 |
| 5 | 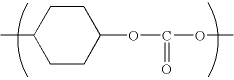 | 1.52 | 57 |
| 6 | 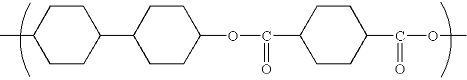 | 1.54 | 55 |
| 7 | 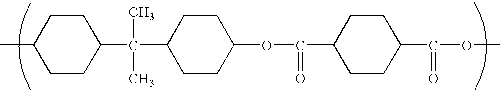 | 1.53 | 57 |
| 8 | 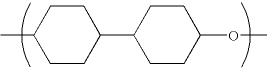 | 1.55 | 57 |
| 9 | 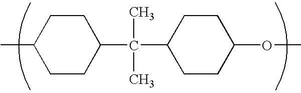 | 1.54 | 57 |
| 10 | 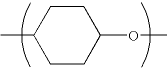 | 1.55 | 58 |
| 11 | 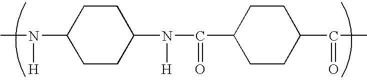 | 1.55 | 53 |
| 12 | 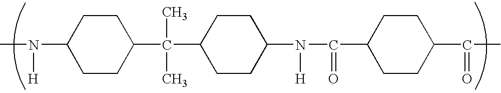 | 1.54 | 55 |
| 13 | 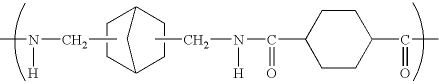 | 1.54 | 56 |
| 14 | 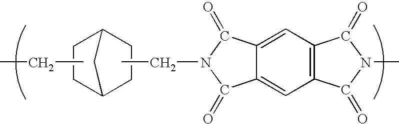 | 1.58 | 43 |

### (2) Curable Resin

The curable resin is one which is curable via operation of actinic energy radiation exposure of UV, electron beam or the like, or heat treatment, and can be used without any limitation, provided that it is one which forms a transparent resin composition via curing after mixture with the foregoing thermoplastic resin in an uncured state. An epoxy resin, a vinyl ester resin, a silicone resin and so forth are preferably usable.

For example, when an epoxy resin is employed as a curable resin, any one is usable, provided that it is one having at least two epoxy groups in the molecule. Specific examples thereof include a bisphenol A type epoxy resin, a phenol novolac type epoxy resin, an o-cresol novolac type epoxy resin, a triphenyl methane type epoxy resin a halogenated epoxy resin such as a bromine-containing epoxy resin or the like, an epoxy resin containing a naphthalene ring, and so forth. An aromatic epoxy resin may be a hydrogen addition type epoxy resin which is cyclohexane-cyclized via nucleus hydrogenation of an aromatic ring. These epoxy resins may be used singly, or in combination of at least two kinds.

As a hardener of the epoxy resin, it is not particularly limited, but example thereof include an acid anhydride hardener, a phenol hardener and so forth.

Specific examples of the acid anhydride hardener include phthalic anhydride, maleic anhydride, trimellitic anhydride, pyromellitic anhydride, hexahydrophthalic anhydride, 3-methyl-hexahydrophthalic anhydride, 4-methyl-hexahydrophthalic anhydride, an admixture of 3-methyl-hexahydrophthalic anhydride, 4-methyl-hexahydrophthalic anhydride, nadic anhydride, methylnadic anhydride and so forth.

A hardening accelerator is also contained, if desired. The hardening accelerator is not particularly limited, as long as the hardening accelerator exhibiting excellent hardenability is uncolored, and transparency of a thermosetting resin is not deteriorated, but usable examples thereof include imidazoles such as 2-ethyl-4-methylimidazole (2E4MZ, produced by Shikoku Kasei-Kogyo Co., Ltd.) or the like, tertiary amine, quaternary ammonium salt, bicyclic amidines such as diazabicycloundecene or the like and derivatives thereof, phosphine, a phosphonium salt, and so forth. These may be used singly or in combination of at least two kinds.

### (3) Inorganic Particle

Inorganic particles of the present invention have an average particle diameter of 1-50 nm, preferably have an average particle diameter of 1-30 nm, more preferably have an average particle diameter of 1-20 nm, and still more preferably have an average particle diameter of 1-10 nm in view of acquisition of transparency, when a resin composition containing the particles is applied to an optical element, since the particles are present in a situation where they are dispersed in a resin. In the case of an average particle diameter of less than 1 nm, desired properties tend not to be obtained since it is difficult to disperse inorganic particles. Further, in the case of an average diameter exceeding 50 nm, light transmittance tend to be less than 70% since transparency is lowered because of turbidity of the resulting resin composition. The average particle diameter herein means a diameter obtained via conversion into the sphere having the same volume as that of the particle.

Shape of the inorganic particle is not specifically limited, but spherical particles are preferably employed. Further, the distribution of particles is not specifically limited, but one having a relatively narrow distribution rather than one having a wide distribution is preferably used in order to produce effects of the present invention efficiently.

Inorganic particles are not particularly limited, but are preferably composed of a semiconductor crystal composition, inorganic oxide, or an admixture of the semiconductor crystal composition and the inorganic oxide. For example, as the inorganic particles, oxide particles are employable. Specific examples thereof include titanium oxide, zinc oxide, aluminum oxide, zirconium oxide, hafnium oxide, niobium oxide, tantalum oxide, magnesium oxide, calcium oxide, strontium oxide, barium oxide, yttrium oxide, lanthanum oxide, cerium oxide, indium oxide, tin oxide, lead oxide, lithium niobate, potassium niobate, lithium tantalate or the like as a double oxide composed of these oxides, and phosphates, sulfates or the like formed in combination with these oxides.

Further, semi-conductor crystal compositions utilized as inorganic particles are not particularly limited, but those exhibiting neither absorption, nor light emission and fluorescence within the wavelength range applied for the optical element are preferable. Specific examples of the composition include: elements of Group 14 of periodic table such as carbon, silicon, germanium and tin; elements of Group 15 of periodic table such as phosphorus (black phosphorous); elements of Group 16 of periodic table such as selenium and tellurium; compounds composed of elements of Group 14 of periodic table such as silicon carbide SiC; compounds composed of an element of Group 14 and that of Group 16 of periodic table such as tin oxide(IV) SnO₂, tin sulfide(II, IV) Sn(II)Sn(IV)S₃, tin sulfide (IV) SnS₂, tin sulfide (II) SnS, tin(II) selenide SnSe, tin(II) telluride SnTe, lead(II) sulfide PbS, lead(II) selenide PbSe and lead(II) telluride PbTe; compounds of an element of Group 13 and that of Group 15 of periodic table (or semi-conductor compounds of Group III-V) such as boron nitride BN, boron phosphide BP, boron arsenide BAs, aluminum nitride AlN, aluminum phosphide AlP, aluminum arsenide AlAs, aluminum antimonide AlSb, gallium nitride GaN, gallium phosphide GaP, gallium arsenide GaAs, gallium antimonide GaSb, indium nitride InN, indium phosphide InP, indium arsenide InAs and indium antimonide InSb; compounds of an element of Group 13 and that of Group 16 of periodic table such as aluminum sulfide Al₂S₃, aluminum selenide Al₂Se₃, gallium sulfide Ga₂S₃, gallium selenide Ga₂Se₃, gallium telluride Ga₂Te₃, indium oxide In₂O₃, indium sulfide In₂S₃, indium selenide In₂Se₃ and indium telluride In₂Te₃; compounds of an element of Group 13 and that of Group 17 of periodic table such as thallium(I) chloride TlCl, thallium(I) bromide TlBr and thallium(I) iodide TlI; compounds of an element of Group 12 and that of Group 16 of periodic table (or semiconductor compounds of Group II to VI) such as zinc oxide ZnO, zinc sulfide ZnS, zinc selenide ZnSe, zinc telluride ZnTe, cadmium oxide CdO, cadmium sulfide CdS, cadmium selenide CdSe, cadmium telluride CdTe, mercury sulfide HgS, mercury selenide HgSe and mercury telluride HgTe; compounds of an element of Group 15 and that of Group 16 of periodic table such as arsenic(III) sulfide As₂S₃, arsenic(III) selenide As₂Se₃, arsenic(III) telluride As₂Te₃, antimony(III) sulfide Sb₂S₃, antimony(III) selenide Sb₂Se₃, antimony(III) telluride Sb₂Te₃, bismuth(III) sulfide Bi₂S₃, bismuth(III) selenide Bi₂Se₃ and bismuth(III) telluride Bi₂Te₃; compounds of an element of Group 11 and that of Group 16 of periodic table such as copper(I) oxide Cu₂O and copper(I) selenide Cu₂Se; compounds of an element of Group 11 and that of Group 17 of periodic table such as copper(I) chloride CuCl, copper(I) bromide CuBr, copper(I) iodide CuI, silver chloride AgCl and silver bromide AgBr; compounds of an element of Group 10 and that of Group 16 of periodic table such as nickel(II) oxide NiO; compounds of an element of Group 9 and that of Group 16 of periodic table such as cobalt(II) oxide CoO and cobalt(II) sulfide CoS; compounds of an element of Group 8 and that of Group 16 of periodic table such as iron(II) diiron(III) oxide Fe₃O₄ and iron(II) sulfide FeS; compounds of an element of Group 7 and that of Group 16 of periodic table such as manganese(II) oxide MnO; compounds of an element of Group 6 and that of Group 16 of periodic table such as molybdenum(IV) sulfide MoS₂ and tungsten(IV) oxide WO₂; compounds of an element of Group 5 and that of Group 16 of periodic table such as vanadium(II) oxide VO, vanadium(IV) oxide VO₂ and tantalum(V) oxide Ta₂O₅; compounds of an element of Group 4 and that of Group 16 of periodic table such as titanium oxide TiO₂ Ti₂O₅, Ti₂O₃ and Ti₅O₉; compounds of an element of Group 2 and that of Group 16 of periodic table such as magnesium sulfide MgS and magnesium selenide MgSe; charcogen spinel such as cadmium(II) chromium(III) oxide CdCr₂O₄, cadmium(II) chromium(III) selenide CdCr₂Se₄, copper(II) chromium(III) sulfide CuCr₂S₄ and mercury(II) chromium(III) selenide HgCr₂Se₄; and barium titanate BaTiO₃. In addition, a semi-conductor cluster having a confirmed structure such as (BN)₇₅(BF₂)₁₅F₁₅ described in G. Schmid et al., Adv. Mater., vol 4, p. 494, 1991 and Cu₁₄₆Se₇₃(triethylphosphine)₂₂ described in D. Fenske et al., Angew. Chem. Int. Ed. Engl., vol. 29, P. 1452, 1990 is also exemplified.

As these particles, a single kind of inorganic particles may be used, or a plurality of kinds of inorganic particles may be used in combination.

In order to disperse inorganic particles in the order of nanometers in a resin material, inorganic particles are appropriately subjected to a surface treatment. For example, an appropriate surface modifier is added into inorganic particles produced with a sol gel method during hydrolysis in an appropriate solvent to easily conduct the surface treatment.

Examples of the surface modifier to be used for the surface treatment include tetramethoxy silane, tetraethoxy silane, tetraisopropoxy silane, tetrephenoxy silane, methyltrimethoxy silane, ethyltrimethoxy silane, propyltrimethoxysilane, methyltriethoxy silane, methyltriphenoxy silane, ethyltriethoxy silane, phenyltrimethoxy silane, 3-methylphenyltrimethoxy silane, dimethyldimethoxy silane, diethyldiethoxy silane, diphenyldimethoxy silane, diphenyldiphenoxy silane, trimethylmethoxy silane, triethylethoxy silane, triphenylmethoxy silane, triphenylphenoxy silane, cyclopentyltrimethoxy silane, cyclohexyltriethoxy silane, benzyldimethylethoxy silane, octyltriethoxy silane, vinyltriacetoxy silane, vinyltrichloro silane, vinyltriethoxy silane, γ-chloropropyltrimethoxy silane, γ-chloropropylmethyldichloro silane, γ-chloropropylmethyldimethoxy silane, γ-chloropropylethyldiethoxy silane, γ-aminopropyltriethoxy silane, N-(β-aminoethyl)-γ-aminopropyltrimethoxy silane, N-(β-aminoethyl)-γ-aminopropylmethyldimethoxy silane, γ-mercaptopropyltrimethoxysilane, γ-mercaptopropylmethyldimethoxy silane, γ-glycidoxypropyltrimethoxy silane, γ-glycidoxypropylmethyldimethoxy silane, γ-methacryloxypropyltrimethoxy silane, γ-methacryloxypropylmethyldimethoxy silane, 7-(2-aminoethyl)aminopropyltrimethoxy silane, γ-isocyanatepropyltriethoxy silane, γ-(2-aminoethyl)aminopropylmethyldimethoxy silane, γ-anilinopropyltrimethoxy silane, vinyltrimethoxy silane, N-β-(N-vinylbenzilaminoethyl)-γ-aminopropyltrimethoxy silane-hydrochloride salt, and an amino silane composition.

Further, aluminum, titanium, zirconia can be employed in place of silane. In this case, examples thereof include aluminumtriethoxide, aluminumtriisoproxide and so forth.

Also usable are fatty acids such as an isostearic acid, a stearic acid, a cyclopropanecarboxylic acid, a cyclohexanecarboxylic acid, a cyclopentanecarboxylic acid, a cyclohexanepropionic acid, an octylic acid, a palmitic acid, a behenic acid, an undecylenic acid, an oleic acid, a hexahydrophthalic acid and so forth, and derivatives thereof, and further, any of organic phosphoric acid based surface treatment agents. These can be used singly, or used by mixing at least two kinds.

These compounds exhibit different characteristics such as a reaction rate and so forth, and those adapted to the conditions of surface modification can be utilized. These may also be used singly, or in combination of a plurality of kinds. Since the resulting surface-modified particles tend to exhibit different properties depending on the utilized compound, it is also possible to be designed to have affinity with a utilized thermoplastic resin in order to obtain a material composition by selecting the utilized compound during surface modification. The ratio of surface modification is not particularly limited, but the surface modifier preferably has a content of 10-99% by weight, with respect to the weight of particles after surface modification, and more preferably has a content of 30-98% by weight.

### (4) Additives

A stabilizer, a surfactant, resins other than the above-described and so forth may be added into the resin composition. Next, each of (4.1) Stabilizer and (4.2) Surfactant to be added into the resin composition will be described below.

### (4.1) Stabilizer

At least one kind of stabilizers among a hindered amine stabilizer, a phenol stabilizer, a phosphorus stabilizer and a sulfur stabilizer may be added into the resin composition as a stabilizer. Variation of optical properties such as white turbidity caused via continuous exposure to light having, for example, a short wavelength of 400 nm, change in refractive index and so forth can be still more largely inhibited by appropriately selecting these stabilizers to be added into an alicyclic hydrocarbon copolymer.

(4.1.1) Phenol stabilizer

Commonly known phenol stabilizers are preferably usable. For example, acrylate based compounds described in Japanese Patent O.P.I. Publication Nos. 63-179953 and 1-168643 such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol based compounds such as octadecyl-3-(3,5-di-t-butyl-4-hydroxyphenyl)propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenylpropionate)methane, namely pentaerythrimethyl-tetrakis(3-(3,5-di-t-butyl-4-hydroxyphenylpropionate)) and triethylene glycol bis-(3-(3-t-butyl-4-hydroxy-5-methylphenyl)propionate); and triazine group-containing phenol based compounds such as 6-(4-hydroxy-3,5-di-t-butylanilino)-2,4-bisoctyl-1,3,5-triazine, 4-bisoctylthio-1,3,5-triazine and 2-octylthio-4,6-bis-(3,5-di-t-butyl-4-oxyanilino)-1,3,5-triazine are cited.

### (4.1.2) Hindered Amine Stabilizer

Examples of the hindered amine stabilizer include bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl) 2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propioneamide, tetrakis(1,2,2,6,6-pentamethylpiperidyl)butanetetracarboxylate, and so forth.

### (4.1.3) Phosphorus Stabilizer

The phosphorus stabilizer is not specifically limited, as long as it is one used in general resin industries. Preferable examples thereof include a monophosphite based compound such as triphenyl phosphite, diphenyl isodecylphosphite, phenyl diisodecyl phosphite, tris(nonylphenyl)phosphite, tris(dinonylphenyl)phosphite, tris(2,4-di-t-butylphenyl)phosphite, or 10-(3,5-di-t-butyl-4-hydroxybenzyl)-9,10-dihydro-9-oxa-10-phosphaphenanthrene-10-oxide; and a diphosphite based compound such as 4,4′-butylidene-bis(3-methyl-6-t-butylphenyl-di-tridecyl phosphite) and 4,4′-isopropylidene-bis(phenyl-di-alkyl(C12-C15)phosphite), 2,2′-methylenebis(4,6-ditertiary butylphenyl)-2-ethylhexylphosphitr, and so forth. Of these, monophosphite based compounds are preferred, and tris(nonylphenyl)phosphite, tris(dinonylphenyl)phosphite and tris(2,4-di-t-butylphenyl)phosphite are specifically preferable.

### (4.1.4) Sulfur Stabilizer

Preferable examples of the sulfur stabilizer include dilauryl 3,3-thiodipropionate, dimyristyl 3,3′-thiodipropionate, distearyl 3,3-thiodipropionate, lauryl stearyl 3,3-thiodipropionate, pentaerythritol-tetrakis(β-lauryl-thiopropionate), and 3,9-bis(2-dodecylthioethyl)-2,4,8,10-tetra-oxaspiro[5,5]undecane.

The blending quantity of these stabilizers can be appropriately selected as long as it does not deviate the object of the present invention, but the stabilizer has a blending quantity of 0.01-2 parts by weight, with respect to 100 parts by weight of an alicyclic hydrocarbon based copolymer, and more preferably has a blending quantity of 0.01-1 part by weight.

### (4.2) Surfactant

The surfactant is a compound having a hydrophilic group and a hydrophobic group in the identical molecule. The surfactant inhibits white turbidity of the resin composition by adjusting the speed of moisture adhesion to the resin surface as well as of moisture vaporization from the foregoing surface.

Specific examples of the hydrophilic group in the surfactant include a hydroxy group, a hydroxyalkyl group having at least one carbon atom, a hydroxyl group, a carbonyl group, an ester group, an amino group, an amide group, an ammonium salt, thiol, sulfate, phosphate, a polyalkyleneglycol group and so forth. Herein, the amino group may be any of a primary amino group, a secondary amino group and a tertiary amino group.

Specific examples of the hydrophobic group in the surfactant include an alkyl group having six carbon atoms, a silyl group including an alkyl group having six carbon atoms, a fluoroalkyl group having six carbon atoms and so forth. Herein, the alkyl group having six carbon atoms may possess an aromatic ring as a substituent. Specific examples of the alkyl group include hexyl, heptyl, octyl, nonyl, decyl, undecenyl, dodecyl, tridecyl, tetradecyl, myristyl, stearyl, lauryl, palmityl, cyclohexyl and so forth. As the aromatic ring, a phenyl group and so forth can be provided.

This surfactant may possess at least one hydrophilic group and one hydrophobic group each in the identical molecule, or may possess two hydrophilic group and two hydrophobic group each.

Further specific examples of such the surfactant include myristyl diethanolamine, 2-hydroxyethyl-2-hydroxyldodexylamine, 2-hydroxyethyl-2-hydroxytridecylamine, 2-hydroxyethyl-2-hydroxytetradecylamine, pentaerythritolmonostearate, pentaerythritoldistearate, pentaerythritoltristearate, di-2-hydroxyethyl-2-hydroxydodecylamine, alkyl (8-18 carbon atoms) benzyldimethylammonium chloride, ethylene bis alkyl (8-18 carbon atoms) amide, stearyl diethanolamide, lauryl diethanolamide, myristyl diethanolamide, palmityl diethanolamide, and so forth. Of these, amine compounds and amide compounds having a hydroxyalkyl group are preferably used. In the present invention, these compounds may be used in combination of at least two kinds.

With respect to 100 parts by weight of a alicyclic hydrocarbon based polymer, added is 0.01-10 parts by weight of the surfactant. When an addition amount of the surfactant is less than 0.01 parts by weight, white turbidity of the molding product caused by variation in temperature and humidity can not be efficiently inhibited. On the other hand, in the case of the addition amount exceeding 10 parts by weight, light transmittance of the molding product is lowered, whereby application for an optical pickup apparatus becomes difficult. The addition amount of the surfactant is preferably 0.05-5 parts by weight, with respect to 100 parts by weight of the alicyclic hydrocarbon based polymer, and more preferably 0.3-3 parts by weight.

### (5) Method of Manufacturing Optical Element.

A method of manufacturing an optical element of the present invention possesses the steps of preparing a resin composition after mixing the above-described thermoplastic resin, a curable resin, inorganic particles, additives and the like; and molding the resin composition in the predetermined form by curing the resin composition after the foregoing preparation step.

Next, (5.1) Preparation step and (5.2) Molding step each are described.

### (5.1) Preparation Step

Appropriate methods can be employed for the preparation step.

In cases where a resin composition to be prepared is in the form of liquid, for example, each component in a predetermined amount is blended, and subsequently dissolved while mixing to obtain a curable resin composition in the form of liquid. Or, after each component in a predetermined amount is blended, and evenly mixed with a mixer, blender or the like, the resulting may be heat-kneaded by a kneader, a roll or the like to obtain a curable resin composition in the form of liquid.

Further, in cases where a resin composition to be prepared is in the form of a solid, each component in a predetermined amount is blended and subsequently dissolved while mixing. The resulting is cold-solidified, and subsequently pulverized to obtain the resin composition in the form of a solid. Or, after each component in a predetermined amount is blended, and evenly mixed with a mixer, blender or the like, the resulting having been subjected to heat-kneading with a kneader, a roll or the like may be cold-solidified, and subsequently pulverized to obtain the resin composition in the form of a solid.

In cases where a thermoplastic resin, a curable resin, and inorganic particles, after mixing the thermoplastic resin and the inorganic particles, the curable resin may be mixed in this admixture; after mixing the curable resin and the inorganic particles, the thermoplastic resin may be mixed in this admixture; after mixing the thermoplastic resin and the curable resin, inorganic particles may be mixed in this admixture; or the thermoplastic resin, the curable resin, and the inorganic particles may be mixed at the same time. In addition, when inorganic particles are mixed in an admixture, the inorganic particles are preferably introduced from a feeder of a mixer.

### (5.2) Molding Step

In the molding step, a resin composition can be molded in a predetermined form by curing a curable resin in the resin composition obtained in the above-described preparation step via light or heat to manufacture an optical element of the present invention.

Specifically, in cases where the curable resin is a UV radiation or electron beam curable resin, the resin composition is filled in a transparent die in a predetermined form, or after coating the resin composition on a substrate, it may be exposed to UV radiation or electron beams. On the other hand, in cases where the curable resin is a thermoplastic resin, molding while curing may be conducted via compression-molding, transfer-molding, injection molding or the like.

Further, in cases where an optical element (polarizer, for example) in the form of a sheet or a film is prepared, “light curing resin” cured via exposure to actinic energy radiation such as visible light, UV radiation, electron beams or the like is preferably utilized as a curable resin. In this case, a resin composition is filled in a transparent die in a predetermined form, or after coating the resin composition on a substrate, the resin composition is exposed to actinic energy radiation such as visible light, UV radiation, electron beams or the like to mold the resin composition in the predetermined form.

On the other hand, in cases where an optical element (objective lens, for example) having a fine structure provided on an optical surface, and in the form of a spherical surface or an aspheric surface as an optical surface is prepared, “thermosetting resin” cured with heat is preferably utilized as a curable resin. In this case, a resin composition is heated at temperature where a thermoplastic resin (temperature at which the thermosetting resin is not cured) is dissolved, and the dissolved resin composition is molded via compression-molding, transfer-molding, injection molding or the like, and then, temperature is raised again with heat up to temperature at which a thermosetting resin contained in the resin composition is cured, and the thermosetting resin is cured to mold the resin composition in a predetermined form.

In addition, the resin composition in combination of a thermoplastic resin and a thermosetting resin is more preferable than that in combination of a thermoplastic resin and a light curing resin on the point that molding can be conducted by nearly the same commonly known technique as a technique of molding the thermoplastic resin.

### (6) Optical Pickup Apparatus

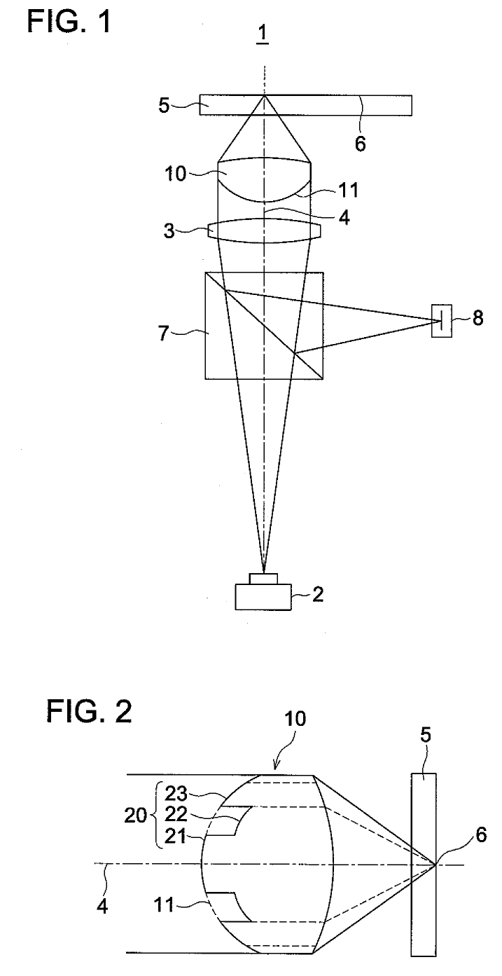

Next, An optical pickup apparatus of the present invention will be described referring to FIG. 1 and FIG. 2.

Optical pickup apparatus 1 of the present invention is an apparatus to reproduce and record information with two types of optical information recording media 5 such as a conventional DVD suitably matched with light having a wavelength of 650 nm (hereinafter, referred to as conventional DVD), and a so-called next generation DVD suitably matched with light having a wavelength of 405 nm (hereinafter, referred to as next generation DVD).

Optical pickup apparatus allows laser light (light) emitted from light source 2 to pass through single-lens optical elements such as collimator lens 3 and objective lens 10, and light is collected at information recording surface 6 of optical information recording medium 5 on optical axis 4 to form a collimation spot, whereby light reflected from information recording surface 6 is let in with polarization beam splitter 7 to form a beam spot again on the light-receiving surface of detector 8.

Light source 2 fitted with a laser diode is arranged to be placed, and is of a structure capable of producing light emission via selection of either light having a wavelength of 650 nm or light having a wavelength of 405 nm.

Each member of collimator lens 3, objective lens 10 and polarization beam splitter 7 constitutes an optical element unit by which irradiation onto optical information recording medium 5 with light emitted from light source 2 and/or collimation of light reflected on optical information recording medium 5 are (is) conducted.

Objective lens 10 as an optical element of the present invention is an optical element having the predetermined fine structure on at least one optical surface, and is formed from the above-described resin composition.

As shown in FIG. 2, objective lens 10 which is a both side aspherical single-lens optical element has previously determined optical path difference providing structure 20 (fine structure), with respect to the predetermined light passing through optical surface 11, on optical surface 11 on one side (light source 2 side).

Optical path difference providing structure 20 is composed of three orbicular zone-shaped lens surfaces in which optical surface 11 places optical axis 4 as a center (hereinafter, referred to as first orbicular zone-shaped lens surface 21, second orbicular zone-shaped lens surface 22, and third orbicular zone-shaped lens surface 23 in order from the inner side). Among three orbicular zone-shaped lens surfaces 21-23, orbicular lens zone-shaped surfaces 21-23 lying next to each other exhibit different refractive power.

First orbicular zone-shaped lens surface 21 and third orbicular zone-shaped lens surface 23 are on the identical optical surface 11, and the second orbicular lens surface is a surface which is moved in parallel from optical surface 11.

First orbicular zone-shaped lens surface 21 lets both light having a wavelength of 650 nm and light having a wavelength of 405 nm pass through, second orbicular zone-shaped lens surface 22 lets light having a wavelength of 650 nm suitably matched with the conventional DVD pass through, and third orbicular zone-shaped lens surface 23 lets light having a wavelength of 405 nm suitably matched with the next generation DVD pass through. In addition, light passed through each of orbicular zone-shaped lens surfaces 21-23 is designed to be collected at the same position on information recording surface 6 (that is, objective lens 10 as an optical element has a collimation function).

In addition, in FIG. 2, first orbicular zone-shaped lens surface 21 and third orbicular zone-shaped lens surface 23 are provided on the identical optical surface, but first and first orbicular zone-shaped lens surface 21 and third orbicular zone-shaped lens surface 23 ar not necessarily provided on the identical optical surface, and though second orbicular zone-shaped lens surface 22 is a surface which is moved in parallel from optical surface 11, it may not be necessarily a surface which is moved in parallel. Further, there may be five orbicular zone-shaped lens surfaces in place of three orbicular zone-shaped lens surfaces 21-23 may be five, and there may be at least three orbicular zone-shaped lens surfaces.

Objective lens 10 contains the foregoing cyclic olefin resin, and when it is melted and injection-molded in a die, it reliably reaches all portions corresponding to boundary portions of first orbicular zone-shaped lens surface 21, second orbicular zone-shaped lens surface 22 and third orbicular zone-shaped lens surface 23 of the die to provide optical path difference providing structure 20 with high accuracy.

Objective lens 10 is possible to reliably collect light emitted at light source 2 onto information recording surface 6, and collect light reflected on information recording surface 6 toward detector 8 via action of optical path difference providing structure 20 formed in this way, with respect to plural kinds of optical information recording media 5 such as the conventional DVD and the next generation DVD. Objective lens 10 obtained by molding a resin composition as described above exhibits a high light transmittance of at least 85% with respect to light having a wave length of 400 nm in a situation of the molding having a thickness of 3 mm. Accordingly, the above-described collection of light can be conducted efficiently. Therefore, since power consumption of light source 2 can be minimized, power consumption of optical pickup apparatus 1 as a whole can be reduced.

In addition, when the resin composition constituting objective lens 10 contains an antioxidant, objective lens 10 exhibits almost neither white turbidity nor variation in refractive index even in the case of transmission of light having a wavelength of 405 nm to reproduce and record information of the next generation DVD. Therefore, optical pickup apparatus 1 can be operated with high pickup characteristic for a long duration.

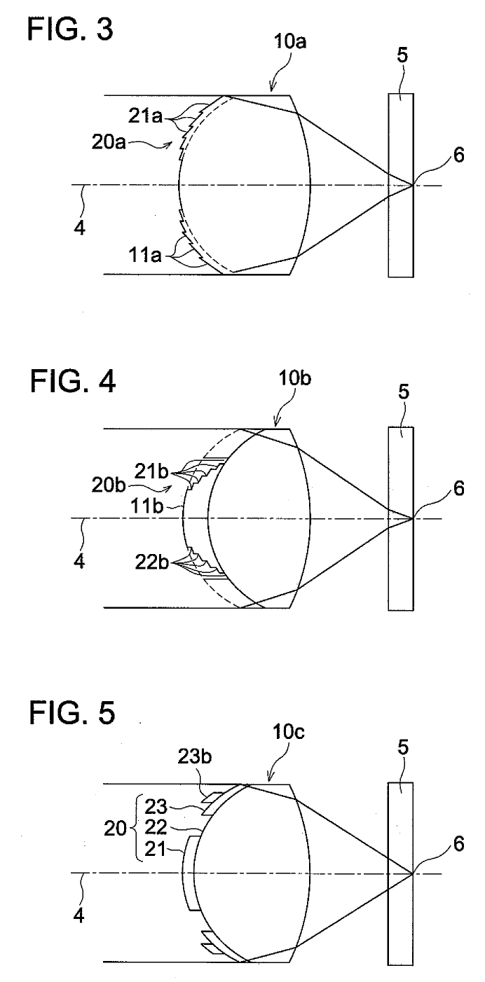

In addition, objective lens 10 is not limited to optical path difference providing structure 20 described above, and may be objective lenses 10a-10e having optical path difference providing structures 20a-20d, as shown in FIG. 3-FIG. 7.

Optical path difference providing structure 20a shown in FIG. 3 is composed of plural diffractive orbicular zones 21a with optical axis 4 as a center, whose cross-sectional surfaces are saw tooth-shaped, and optical surface 11a of each of diffractive orbicular zones 21a is a discontinuous surface. Further, plural diffractive orbicular zones 21a are formed so as to be thicker as distance from optical axis 4. Objective lens 10a shown in FIG. 3 is a so-called diffractive lens.

Optical path difference providing structure 20b shown in FIG. 4 is composed of plural orbicular zone-shaped concave portions 21b producing phase difference with optical axis 4 as a center in the form of concentric circle. There are formed five orbicular zone-shaped concave portions 21b on one surface (there are upper and lower surfaces with optical axis 4 as a center in FIG. 4) with optical axis 4 of optical surface 11b as a center. Further, orbicular zone-shaped concave portions 21b lying next to each other are continuously integrated, and the cross sectional surface of each of orbicular zone-shaped concave portions 21b as a whole is of stair-like appearance. Further, optical surface 22b to form each of orbicular zone-shaped concave portions 21b is a surface which is moved in parallel with respect to optical surface 11b. Objective lens 10b shown in FIG. 4 is a so-called phase difference lens.

In addition, in FIG. 4, orbicular zone-shaped concave portions 21b lying next to each other are continuously integrated, and the cross sectional surface as a whole has stair-like appearance, but simply, orbicular zone-shaped concave portion 21b may be individually provided on optical surface 11b (in this case, it becomes the same structure as that of objective lens 10 as shown in FIG. 2). Further, in FIG. 4, orbicular zone-shaped concave portion 21b is in the form of concentric circle, but as shown in FIG. 5, objective lens 10c may possess orbicular zone-shaped convex portion 23b on third orbicular zone-shaped lens surface 23 in FIG. 2 (in FIG. 5, the same symbols were applied to the same constituent portions as in FIG. 2).

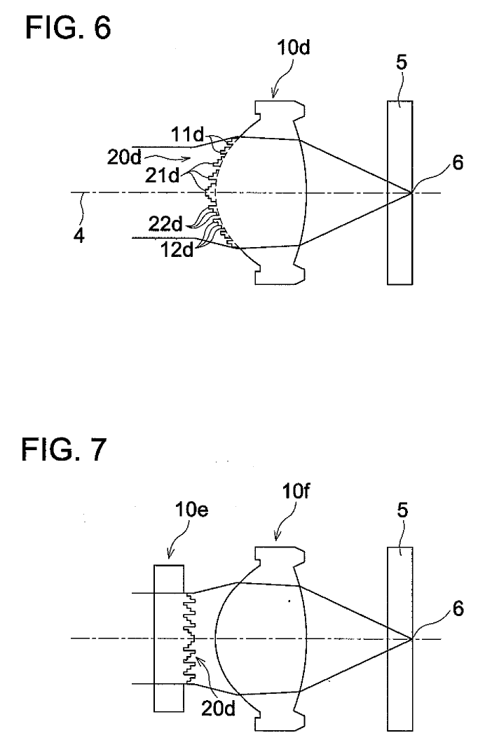

Optical path difference providing structure 20d shown in FIG. 6 is composed of plural diffractive orbicular zones 21d with optical axis 4 as a center, whose cross-sectional surfaces are saw tooth-shaped, and optical surface 11d of each of diffractive orbicular zones 21d is a discontinuous surface. In addition, the cross sectional surface of each of diffractive orbicular zones 21d has 3 stage 22d stair-like appearance along the optical axis direction, optical surface 12d of each stage 22d is discontinuous, and is orthogonal to optical axis 4.

In addition, objective lens 10d shown in FIG. 6, for example, may have a structure in which hologram optical element (HOE) 10e having the same optical path difference providing structure 20d as in FIG. 6, and objective lens 10f are individually provided as shown in FIG. 7. In this case, hologram optical element 10e uses a plane-shaped optical element, and optical path difference providing structure 20d is provided on the surface of objective lens 10f of the optical element.

In addition, optical pickup apparatus 1 of the present invention may reproduce and record information for three types of optical information recording media 5 of, for example, CD, conventional DVD, and next generation DVD. The combination of optical information recording media 5 to reproduce and record information with optical pickup apparatus 1 is of a designing item, and arranged to be set appropriately.

### Example 1

Next, the present invention will be specifically described referring to examples, but the present invention is not limited thereto.

### (1) Preparation of Sample

### (1.1) Preparation of Thermoplastic Resin (A)

After 1000 parts by weight of dry cyclohexane and 200 parts by weight of bicyclo[2.2.1]hepta-2-ene were charged into a stainless autoclave, and the inside of the autoclave was subsequently replaced by ethylene gas, 0.073 parts by weight of methyl aluminoxane (MAO) in terms of aluminum atom conversion and 0.003 parts by weight of bis(cyclopentadienyl)zirconium dichloride were added to the autoclave, and after conducting polymerization reaction at 25° C. at normal pressure for 10 hours while circulating ethylene gas at a flow rate of 50 liter/hr, a small amount of isobutyl alcohol was added to terminate polymerization. After a total amount of polymer was precipitated by charging this reaction solution into a mixed solvent of acetone and methanol, the copolymer was filtered and dried under reduced pressure at 80° C. for 48 hours to obtain “thermoplastic resin (A)”.

### (1.2) Preparation of Thermoplastic Resin (B)

After the inside of a stainless reaction vessel equipped with a stirrer was sufficiently dried and replaced by nitrogen 300 parts by weight of dehydrated cyclohexane, 60 parts by weight of styrene and 0.38 parts of dibutyl ether were charged into this, and 0.36 parts by weight of a n-butyl lithium solution (hexane solution having a content of 15%) was added into this polymerizable monomer solution while stirring at 60° C. to initiate polymerization reaction. After conducting the polymerization reaction for one hour, a monomer mixture containing 8 parts by weight of styrene and 12 parts by weight of isoprene was added into the reaction solution, and the polymerization reaction was further continued for one hour. Subsequently, 0.2 parts by weight of isopropyl alcohol was added into the reaction solution to terminate the reaction.

Next, 300 parts by weight of the above-described polymerization reaction solution was transferred into a pressure resistant reaction vessel equipped with a stirrer, and 10 parts by weight of a silica-alumina carrier type nickel catalyst (E22U, manufactured by Nikki Chemicals Industry Co., Ltd, and a carrier amount of nickel of 60%) were added and mixed as a hydrogenation catalyst. After the inside of the reaction vessel was replaced by hydrogen gas, hydrogen was further supplied while stirring the solution, and temperature was set to 160° C., hydrogenation reaction was conducted at a pressure of 4.5 MPa for 8 hours.

After completing the reaction, the reaction solution was filtered to remove a hydrogenation catalyst, and diluted via addition of 800 parts by weight of cyclohexane, then the reaction solution was pored in 3,500 parts by weight of isopropanol to precipitate a copolymer. Next, this copolymer was filtrated, and dried under reduced pressure at 80° C. for 48 hours to obtain “thermoplastic resin (B)”.

### (1.3) Preparation of Inorganic Particle (A)

A solution in which 2.5 parts by weight of pentaethoxy niobium was added into 32.3 parts by weight of 2-methoxyethanol was prepared, and a mixture solution containing 0.35 parts by weight of water and 34.5 parts by weight of 2-methoxyethanol was dropped in the resulting solution while stirring. After stirring at room temperature for 16 hours, concentration of oxide was condensed so as to be 5% by weight to obtain a Nb₂O₅ dispersion. The particle diameter distribution of particles in the resulting Nb₂O₅ dispersion was measured with a dynamic scattering method, whereby an average particle diameter of 6 nm was obtained. Next, after 0.1 mole equal amount of cyclopentyltrimethoxy silane with respect to Nb were added into this dispersion, stirring was conducted at room temperature for 3 hours, and refluxing was further conducted for three hours. After the solution was condensed at 60° C. or less employing a rotary evaporator, solvent replacement was made with cyclohexane to obtain 5% by weight of a Nb₂O₅ dispersion which has been subjected to a surface treatment. This was designated as inorganic particle (A) dispersion.

### (1.4) Preparation of Inorganic Particle (B)

A solution in which 2.0 parts by weight of pentaethoxy niobium was added into 16.6 parts by weight of 2-methoxyethanol was prepared, and a mixture solution containing 0.26 parts by weight of lithium hydroxide-hydrate and 18.3 parts by weight of 2-methoxyethanol was dropped in the resulting solution while stirring. After stirring at room temperature for 16 hours, concentration of oxide was condensed so as to be 5% by weight to obtain a LiNbO₃ dispersion. The particle diameter distribution of particles in the resulting LiNbO₃ dispersion was measured with a dynamic scattering method, whereby an average particle diameter of 5 nm was obtained. Next, after 0.05 mole equal amount of cyclopentyltrimethoxy silane with respect to Nb were added into this dispersion, stirring was conducted at room temperature for 3 hours, and refluxing was further conducted for three hours. After the solution was condensed at 60° C. or less employing a rotary evaporator, solvent replacement was made with cyclohexane to obtain 5% by weight of a LiNbO₃ dispersion which has been subjected to a surface treatment. This was designated as inorganic particle (B) dispersion.

### (1.5) Preparation of Thermoplastic Resin (1)

Into 8.0 parts by weight of cyclohexane, added was 1.0 part by weight of the above-described thermoplastic resin (A), and the resulting was stirred at room temperature for 6 hours employing a stirrer. Into this solution, added were 5% by weight of the above-described inorganic particle (A) in such a way that an addition amount of Nb₂O₅ became an amount of 60% by weight with respect to thermoplastic resin (A), and this solution was stirred at room temperature around the clock. Next, after removing a solvent in this solution, drying was conducted under reduced pressure at 80° C. for 48 hours to obtain thermoplastic resin (1) in which inorganic particles were dispersed.

### (1.6) Preparation of Thermoplastic Resin (2)

Thermoplastic resin (2) in which inorganic particles were dispersed was prepared similarly to preparation of the above-described thermoplastic resin (1), except that thermoplastic resin (A) was replaced by above-described thermoplastic resin (B).

### (1.7) Preparation of Thermoplastic Resin (3)

Into 8.0 parts by weight of cyclohexane, added was 1.0 part by weight of the above-described thermoplastic resin (A), and the resulting was stirred at room temperature for 6 hours employing a stirrer. Into this solution, added were 5% by weight of the above-described inorganic particle (A) in such a way that an addition amount of LiNbO₃ became an amount of 30% by weight with respect to thermoplastic resin (A), and this solution was stirred at room temperature around the clock. Next, after removing a solvent in this solution, drying was conducted under reduced pressure at 80° C. for 48 hours to obtain thermoplastic resin (3) in which inorganic particles were dispersed.

### (1.8) Preparation of Thermoplastic Resin (4)

Thermoplastic resin (4) in which inorganic particles were dispersed was prepared similarly to preparation of the above-described thermoplastic resin (3), except that thermoplastic resin (A) was replaced by above-described thermoplastic resin (B).

### (1.9) Preparation of Examples (1)-(8) and Comparative Examples (1)-(8)

After kneading each raw material in accordance with a blending composition ratio (unit: parts by weight) shown in the following Table 2, 16 kinds of uniform thermoplastic resin compositions were prepared via kneading with a kneading machine. After the resulting resin composition was filled in a die having a size of 30 mm×30 mm×3 mm, and subsequently subjected to a hot press treatment at 220° C. for 20 minutes to obtain a molded plate. These molded plates were designated as Examples (1)-(8) and Comparative examples (1)-(8).

In addition, details of each component other than thermoplastic resins (1)-(4) in the following Table 2 are as follows.

Curable resin (1) : 3,4-epoxycyclohexenylmethyl-3′,4′-epoxycyclohexenecarboxylate (CELLOXIDE 2021, produced by Daicel Chemical Industries, Ltd.)

Curable resin (2): 1,2:8,9 diepoxylimonene (CELLOXIDE 3000, produced by Daicel Chemical Industries, Ltd.)

Hardener: methylhexahydro phthalic anhydride (Epicron, produced by DIC Corporation)

Hardening accelerator : 2-ethyl-4-methylimidazole (2E4MZ, Shikoku Chemicals Corporation)

Stabilizer (1): tetrakis (1,2,2,6,6,-pentamethylpyperidyl) butanetetracarboxylate

Stabilizer (2): tetrakis(methylene-3-(3′,5′-di-t-butyl- 4′-hydroxyphenylpropionate) methane

Stabilizer (3): 2,2′-methylenebis(4,6-ditertiarybutylphenyl)-2-ethylhexyl phosphite

Surfactant: pentaerythritoldistearate

TABLE 2
(Parts by weight)

| | Ex. | Ex. | Ex. | Ex. | Ex. | Ex. | Ex. | Ex. |
|---|---|---|---|---|---|---|---|---|
| | (1) | (2) | (3) | (4) | (5) | (6) | (7) | (8) |
| Curable resin | 30 | 30 | 30 | 30 | — | — | — | — |
| (1) | | | | | | | | |
| Curable resin | — | — | — | — | 30 | 30 | 30 | 30 |
| (2) | | | | | | | | |
| Thermoplastic | 100 | — | — | — | 100 | — | — | — |
| resin (1) | | | | | | | | |
| Thermoplastic | — | 100 | — | — | — | 100 | — | — |
| resin (2) | | | | | | | | |
| Thermoplastic | — | — | 100 | — | — | — | 100 | — |
| resin (3) | | | | | | | | |
| Thermoplastic | — | — | — | 100 | — | — | — | 100 |
| resin (4) | | | | | | | | |
| Thermoplastic | — | — | — | — | — | — | — | — |
| resin (A) | | | | | | | | |
| Thermoplastic | — | — | — | — | — | — | — | — |
| resin (B) | | | | | | | | |
| Hardener | 30 | 30 | 30 | 30 | 30 | 30 | 30 | 30 |
| Hardening | 0.1 | 0.1 | 0.1 | 0.1 | 0.1 | 0.1 | 0.1 | 0.1 |
| accelerator | | | | | | | | |
| Stabilizer (1) | 0.2 | 0.2 | 0.2 | 0.2 | — | — | — | — |
| Stabilizer (2) | — | — | — | — | 0.2 | 0.2 | 0.2 | 0.2 |
| Stabilizer (3) | 0.05 | 0.05 | 0.05 | 0.05 | 0.05 | 0.05 | 0.05 | 0.05 |
| Surfactant | 0.5 | 0.5 | 0.5 | 0.5 | 0.5 | 0.5 | 0.5 | 0.5 |
| | Comp. | Comp. | Comp. | Comp. | Comp. | Comp. | Comp. | Comp. |
| | (1) | (2) | (3) | (4) | (5) | (6) | (7) | (8) |
| Curable resin | — | — | 30 | 30 | — | — | — | — |
| (1) | | | | | | | | |
| Curable resin | — | — | — | — | — | — | — | — |
| (2) | | | | | | | | |
| Thermoplastic | — | — | — | — | 100 | — | — | — |
| resin (1) | | | | | | | | |
| Thermoplastic | — | — | — | — | — | 100 | — | — |
| resin (2) | | | | | | | | |
| Thermoplastic | — | — | — | — | — | — | 100 | — |
| resin (3) | | | | | | | | |
| Thermoplastic | — | — | — | — | — | — | — | 100 |
| resin (4) | | | | | | | | |
| Thermoplastic | 160 | — | 100 | — | 60 | — | 60 | — |
| resin (A) | | | | | | | | |
| Thermoplastic | — | 160 | — | 100 | — | 60 | — | 60 |
| resin (B) | | | | | | | | |
| Hardener | — | — | 30 | 30 | — | — | — | — |
| Hardening | — | — | 0.1 | 0.1 | — | — | — | — |
| accelerator | | | | | | | | |
| Stabilizer (1) | 0.2 | 0.2 | 0.2 | 0.2 | 0.2 | 0.2 | 0.2 | 0.2 |
| Stabilizer (2) | — | — | — | — | — | — | — | — |
| Stabilizer (3) | 0.05 | 0.05 | 0.05 | 0.05 | 0.05 | 0.05 | 0.05 | 0.05 |
| Surfactant | 0.5 | 0.5 | 0.5 | 0.5 | 0.5 | 0.5 | 0.5 | 0.5 |

Ex.: Example,
Comp.: Comparative example

### (2) Evaluation of Examples (1)-(8) and Comparative Examples (1)-(8)

Next, optical properties of molded plates obtained as Examples (1)-(8) and Comparative examples (1)-(8) were evaluated in accordance with the following method, and the results were shown in Table 3.

### (2.1) Transmittance

Transmittance of light having a wavelength of 400 nm of each molded plate in Examples (1)-(8) and Comparative examples (1)-(8) was measured, and each of the molded plates exhibited high transmittance like a light transmittance of at least 90%.

### (2.2) Optical Durability

Each of the molded plates in Examples (1)-(8) and Comparative examples (1)-(8) was applied to a part corresponding to objective lens 10 in optical pickup apparatus 1 described in FIG. 1, the optical pickup apparatus was employed in a constant-temperature and a constant temperature and humidity chamber at 90° C. and 55% RH, each of the molded plates was continuously exposed to light having a wavelength of 405 nm emitted from a laser diode of light source 2 as a circle spot having a diameter of 1 mm for 1500 hours. Subsequently, laser exposure portions were visually observed to evaluate (1) transparency (coloring degree) caused by white turbidity and (2) shape stability in accordance with the following criteria.

### (2.2.1) Coloring Degree

A: After continuous exposure, no white turbidity is observed at the laser exposure portion at all.

B: After continuous exposure, turbidity is slightly observed at the laser exposure portion, but it is practically tolerable.

C: After continuous exposure, turbidity is observed at the laser exposure portion, but it is practically tolerable.

D: After continuous exposure, white turbidity is observed at the laser exposure portion, and it is practically problematic.

### (2.2.2) Shape Satability

A: After continuous exposure, no deformation is observed at the laser exposure portion at all.

B: After continuous exposure, deformation is very slightly observed at the laser exposure portion, but it is practically tolerable.

C: After continuous exposure, deformation is slightly observed at the laser exposure portion, but it is practically tolerable.

D: After continuous exposure, deformation is observed at the laser exposure portion, and it is practically problematic.

TABLE 3

Optical durability

| | Coloring degree | Shape stability |
|---|---|---|
| Example (1) | A | A |
| Example (2) | A | A |
| Example (3) | A | A |
| Example (4) | A | A |
| Example (5) | A | A |
| Example (6) | A | A |
| Example (7) | A | A |
| Example (8) | A | A |
| Comparative | C | C |
| example (1) | | |
| Comparative | C | C |
| example (2) | | |
| Comparative | B | B |
| example (3) | | |
| Comparative | B | B |
| example (4) | | |
| Comparative | B | C |
| example (5) | | |
| Comparative | B | C |
| example (6) | | |
| Comparative | B | C |
| example (7) | | |
| Comparative | B | C |
| example (8) | | |

As is clear from Table 3, it is to be understood that molding products of Examples (1)-(8) molded employing the resin composition of the present invention exhibit neither coloring nor white turbidity even via continuous exposure to light having a short wavelength for a long duration, and further exhibit no deformation, together with highly maintained shape stability.

### Example 2

### (1) Preparation of Example 9

Each of optical elements (objective lenses) having the structures shown in FIGS. 2-7 was prepared with the same molded plate composition as in the above-described Examples (1)-(8) via injection molding. These objective lenses were designated as Example (9).

### (2) Preparation of Comparative Example 9

Each of optical elements (objective lenses) was prepared with the same molded plate composition as in the above-described Comparative examples (1)-(8) by the same method as in Example (9) These objective lenses were designated as Comparative example (9).

### (3) Evaluation

The objective lens of each of Example (9) and Comparative example (9) described above was placed at a part corresponding to objective lens 10 in an optical pickup apparatus described in FIG. 1. Next, recording and reproducing were conducted onto a DVD by using light having a wavelength of 405 mm with a laser diode in the optical pickup apparatus.

As a result, any of the optical pickup apparatuses equipped with the optical element in Example (9) exhibited excellent pickup characteristics together with no onserved deformation, even though they were continuously exposed to light for a long duration. On the other hand, when objective lenses in Comparative example (9) were employed, the finer (complicated) structure of the optical surface is formed, the more deformation is produced, whereby degradation of pickup characteristics was observed.

1. A resin composition comprising a thermoplastic resin, a curable resin, and inorganic particles having an average particle diameter of 1-50 nm.

2. The resin composition of claim 1,
wherein the inorganic particles comprise a semiconductor crystal composition, inorganic oxide, or an admixture of the semiconductor crystal composition and the inorganic oxide.

3. The resin composition of claim 1,
wherein the thermoplastic resin is at least one selected from the group consisting of an acrylic resin, an alicyclic hydrocarbon resin, a polycarbonate resin, a polyester resin, a polyether resin, a polyamide resin and a polyimide resin.

4. The resin composition of claim 3,
wherein the thermoplastic resin is the alicyclic hydrocarbon resin, and the alicyclic hydrocarbon resin is a polymer represented by the following formula (1): 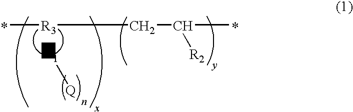
wherein each of x and y represents a copolymerization ratio, and is a real number satisfying 0/100 y/x 95/5; n is 0, 1 or 2, and represents a substitution number of substituent Q; R₁ represents at least one (2+n)-valent group selected from the group consisting of hydrocarbon groups each having 2-20 carbon atoms; R₂ represents a hydrogen atom or at least one monovalent group selected from the group consisting of hydrocarbon groups each having 1-10 carbon atoms; R₃ represents at least one divalent group selected from the group consisting of hydrocarbon groups each having 2-20 carbon atoms; and Q represents at least one monovalent group selected from the group consisting of structures each represented by COOR₄, where R₄ represents a hydrogen atom or at least one monovalent group selected from the group consisting of hydrocarbon groups each having 1-10 carbon atoms.

5. The resin composition of claim 1, comprising a stabilizer selected from the group consisting of a hindered amine stabilizer, a phenol stabilizer, a phosphorus stabilizer and a sulfur stabilizer.

6. An optical element comprising the resin composition of claim 1, as a molding.

7. The optical element of claim 6, comprising the resin composition molded in a predetermined form by curing an uncured curable resin, after mixing the thermoplastic resin, the uncured curable resin and the inorganic particles.

8. The optical element of claim 6, comprising a fine structure provided on at least one optical surface.

9. The optical element of claim 6, comprising a collimation function.

10. The optical element of claim 6, comprising the resin composition, as the molding having a thickness of 3 mm, exhibiting a high light transmittance of at least 85% with respect to light having a wavelength of 400 nm.

11. An optical pickup apparatus to reproduce and/or record information for an optical information recording medium, comprising:
a light source to emit light, and
an optical element unit to conduct irradiation onto light the information recording medium with light emitted from the light source and/or collimation of light reflected on the optical information recording medium,
wherein the optical element unit comprises the optical element of claim 6.

12. The optical pickup apparatus of claim 11, comprising the light source emitting light having a wavelength of 390-420 nm.
